(19) United States
(12) Patent Application Publication
(10) Pub. No.: US 2020/0071540 A1
(43) Pub. Date: Mar. 5, 2020

(54) ANTIMICROBIAL COATING APPLIED TO PROTECTIVE BODY EQUIPMENT SUCH AS HELMETS, SHOULDER PADS, AND ELBOW PADS

(71) Applicant: Parasol Medical LLC, Buffalo Grove, IL (US)

(72) Inventor: Patrick E. Eddy, Allendale, MI (US)

(73) Assignee: Parasol Medical LLC, Buffalo Grove, IL (US)

(21) Appl. No.: 16/120,962

(22) Filed: Sep. 4, 2018

(51) Int. Cl. C09D 5/14; A63B 71/10; A63B 71/12; A42B 3/14; A42B 3/06; A42B 3/12; A01N 55/00

(52) U.S. Cl. CPC C09D 5/14; A63B 71/10; A63B 71/12; A42B 3/14; A63B 2102/18; A42B 3/125; A01N 55/00; A63B 2243/007; A63B 2244/24; A42B 3/066

(57) ABSTRACT

A helmet including a head-facing portion with an exterior surface and an antimicrobial coating applied thereto. The antimicrobial coating includes a silane quaternary ammonium ion or salt thereof. Exemplary silane quaternary ammonium ions or salts thereof include: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, and 3-(trihydroxysilyl)propyldimethyloctadecyl ammonium chloride.

### BACKGROUND OF THE DISCLOSURE

A person sometimes uses protective body equipment while performing acts that might injure the body of the person. For example, a person sometimes uses a helmet to protect the head of the person. Equestrian riders, football players, hockey players, cricket players, baseball and softball players, hard labor workers such as construction workers and miners, motorcycle riders, bicycle riders, and soldiers, among others, all wear a helmet to protect their heads from injury. As another example, a person sometimes uses shoulder pads to protect the upper torso of the person, such as during sporting activities such as football and hockey. Similarly, a person sometimes uses an elbow pad to protect the elbow of the person, such as during sporting activities such as skateboarding. Unfortunately, the protective body equipment can become a harbor for harmful bacteria, microbes, viruses, and the like, which can subsequently be transferred to other users and produce unpleasant odors.

### BRIEF SUMMARY OF THE DISCLOSURE

According to a first aspect of the present disclosure, a helmet comprises: a head-facing portion including an exterior surface; and an antimicrobial coating applied to the exterior surface of the head-facing portion; wherein, the antimicrobial coating includes a silane quaternary ammonium ion or salt thereof.

Embodiments of the first aspect of the disclosure can include any one or a combination of the following features:
the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride;
the helmet is an equestrian riding helmet, the head-facing portion includes padding, and the antimicrobial coating is applied to the exterior surface of the padding;
the helmet is a football helmet, the head-facing portion includes one or more of padding and liner, and the antimicrobial coating is applied to the exterior surface of the one or more included padding and liner;
the helmet is a hockey helmet, the head-facing portion includes padding, and the antimicrobial coating is applied to the exterior surface of the padding;
the helmet is a cricket helmet, the head-facing portion includes one or more of padding and liner, and the antimicrobial coating is applied to the exterior surface of the one or more included padding and liner;
the helmet is a batting helmet, the head-facing portion includes padding, and the antimicrobial coating is applied to the padding;
the helmet is a hardhat, the head-facing portion includes a suspension mechanism, and the antimicrobial coating is applied to the exterior surface of the suspension mechanism;
the helmet is a motorcycle helmet, the head-facing portion includes padding, and the antimicrobial coating is applied to the exterior surface of the padding;
the helmet is a bicycle helmet, the head-facing portion includes padding, and the antimicrobial coating is applied to the exterior surface of the padding;
the helmet is a combat helmet, the head-facing portion includes one or more of padding and liner, and the antimicrobial coating is applied to the exterior surface of the one or more included padding and liner; and
a strap including an exterior surface, and the antimicrobial coating is further applied to the exterior surface of the strap.

According to a second aspect of the present disclosure, sporting shoulder pads comprise: a left side body arch member and a right side body arch member, each including a front portion and a back portion; an interior pad assembly coupled to the left side body arch member and the right side body arch member; a left side adjustable belt arrangement coupled to the front portion and the rear portion of the left side body arch member; a right side adjustable belt arrangement coupled to the front portion and the rear portion of the right side body arch member; and an antimicrobial coating applied to an exterior surface of the interior pad assembly; wherein, the antimicrobial coating includes a silane quaternary ammonium ion or salt thereof.

Embodiments of the second aspect of the disclosure can include any one or a combination of the following features:
the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride; and
the antimicrobial coating is further applied to an exterior surface of the left side adjustable belt arrangement and the right side adjustable belt arrangement.

According to a third aspect of the present disclosure, a sporting elbow pad comprises: a sleeve; a padding element supported by the sleeve; and an antimicrobial coating applied to an exterior surface of the sleeve; wherein, the antimicrobial coating includes a silane quaternary ammonium ion or salt thereof.

Embodiments of the third aspect of the disclosure can include any one or a combination of the following features:
the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride; and
   adjustment straps attached to the sleeve, and the antimicrobial coating is further applied to an exterior surface of the adjustment straps.

These and other features, advantages, and objects of the present disclosure will be further understood and appreciated by those skilled in the art by reference to the following specification, claims, and appended drawings.

### BRIEF DESCRIPTION OF THE DRAWINGS

FIG. 1A is a perspective view of a person riding a horse while wearing an equestrian helmet on the head of the person;

FIG. 1B is a perspective view of a head-facing portion of the equestrian helmet of FIG. 1A, illustrating an exterior surface;

FIG. 1C illustrates an antimicrobial coating applied over the exterior surface of the head-facing portion of the equestrian helmet of FIG. 1A;

FIG. 2A is a perspective view of a football helmet;

FIG. 2B is a bottom view of a head-facing portion of the football helmet of FIG. 2A, illustrating an exterior surface;

FIG. 2C illustrates an antimicrobial coating applied over the exterior surface of the head-facing portion of the football helmet of FIG. 2A;

FIG. 3A is a perspective view of a hockey helmet;

FIG. 3B is a bottom view of a head-facing portion of the hockey helmet of FIG. 3A, illustrating an exterior surface;

FIG. 3C illustrates an antimicrobial coating applied over the exterior surface of the head-facing portion of the hockey helmet of FIG. 3A;

FIG. 4A is a perspective view of a cricket helmet;

FIG. 4B is a bottom view of a head-facing portion of the cricket helmet of FIG. 4A, illustrating an exterior surface;

FIG. 4C illustrates an antimicrobial coating applied over the exterior surface of the head-facing portion of the cricket helmet of FIG. 4A;

FIG. 5A is a perspective view of a batting helmet;

FIG. 5B is a bottom view of a head-facing portion of the batting helmet of FIG. 5A, illustrating an exterior surface;

FIG. 5C illustrates an antimicrobial coating applied over the exterior surface of the head-facing portion of the batting helmet of FIG. 5A;

FIG. 6A is a perspective view of a hardhat;

FIG. 6B is a perspective bottom view of a head-facing portion of the hardhat of FIG. 6A, illustrating an exterior surface;

FIG. 6C illustrates an antimicrobial coating applied over the exterior surface of the head-facing portion of the hardhat of FIG. 6A;

FIG. 7A is a perspective view of a motorcycle helmet;

FIG. 7B is a bottom view of a head-facing portion of the motorcycle helmet of FIG. 7A, illustrating an exterior surface;

FIG. 7C illustrates an antimicrobial coating applied over the exterior surface of the head-facing portion of the motorcycle helmet of FIG. 7A;

FIG. 8A is a perspective view of a bicycle helmet;

FIG. 8B is a bottom view of a head-facing portion of the bicycle helmet of FIG. 8A, illustrating an exterior surface;

FIG. 8C illustrates an antimicrobial coating applied over the exterior surface of the head-facing portion of the bicycle helmet of FIG. 8A;

FIG. 9A is a perspective view of a combat helmet;

FIG. 9B is a perspective bottom view of a head-facing portion of the combat helmet of FIG. 9A, illustrating an exterior surface;

FIG. 9C illustrates an antimicrobial coating applied over the exterior surface of the head-facing portion of the combat helmet of FIG. 9A;

FIG. 10A is a front view of sporting shoulder pads, illustrating an interior padding assembly with a liner, both having exterior surfaces;

FIG. 10B is a rear view of the sporting shoulder pads of FIG. 10A;

FIG. 10C illustrates an antimicrobial coating applied over the exterior surfaces of the interior padding assembly of the of FIG. 10A;

FIG. 11A is a perspective view of a sporting elbow pad, illustrating a sleeve having an exterior surface; and

FIG. 11B is another perspective view of the sporting elbow pad of FIG. 11A, illustrating the antimicrobial coating applied over the exterior surface of the sleeve.

### DETAILED DESCRIPTION

For purposes of description herein, it is to be understood that the specific devices and processes illustrated in the attached drawings, and described in the following specification are simply exemplary embodiments of the inventive concepts defined in the appended claims. Hence, physical characteristics relating to the embodiments disclosed herein are not to be considered as limiting, unless the claims expressly state otherwise.

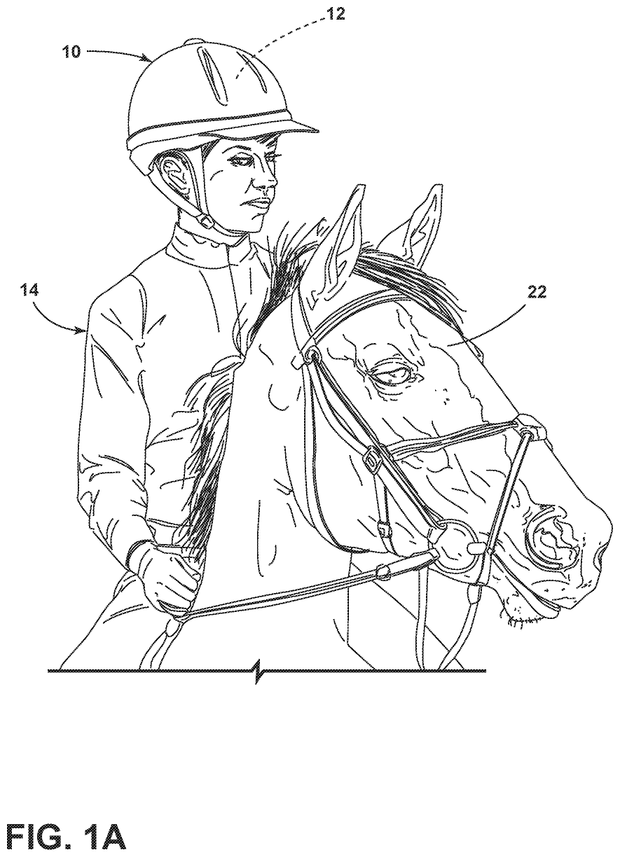

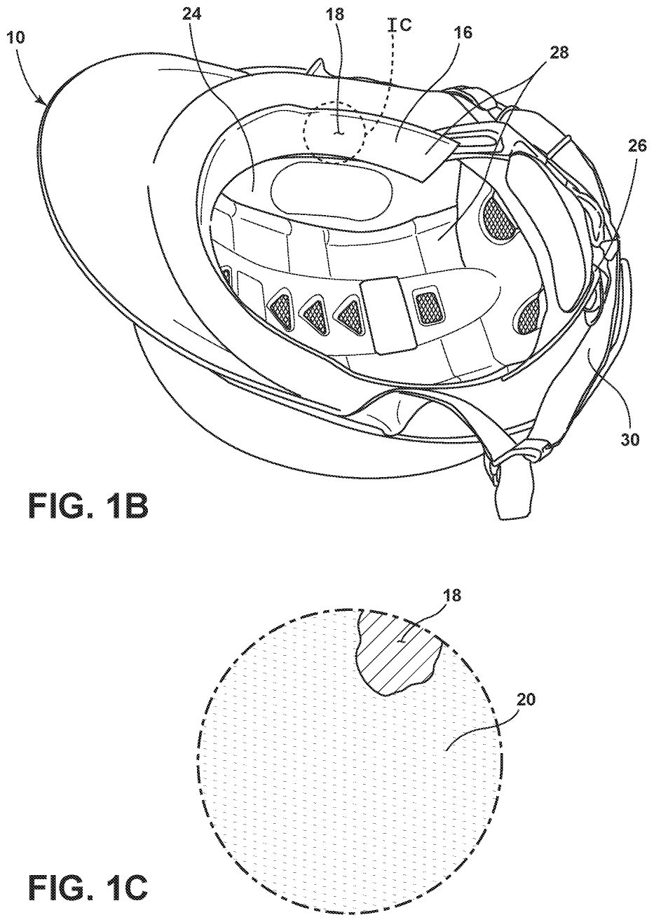

Referring to FIGS. 1A-1C, a helmet 10 covers a head 12 of a person 14. The helmet 10 protects the head 12 of the person 14 from injury. The helmet 10 includes a head-facing portion 16. The head-facing portion 16 of the helmet 10 is the portion of the helmet 10 configured to face the head 12 of the person 14 wearing the helmet 10 during normal use of the helmet 10. The head-facing portion 16 of the helmet 10 may partially surround the head 12 of the person 14. The head-facing portion 16 includes an exterior surface 18. The exterior surface 18 is closest to the head 12 of the person 14 and likely to make contact with the head 12 of the person 14 during normal use. The exterior surface 18 harbors or acts as a gateway to other parts of the helmet 10 for harmful microbes, viruses, bacteria, and the like, which can produce unpleasant odor. The exterior surface 18 can contact sweat and other forms of moisture and become moldy and musty. To help prevent these undesirable consequences, an antimicrobial coating 20 is applied to the exterior surface 18 of the head-facing portion 16. The antimicrobial coating 20 can be applied to an exterior surface 18 of other components of the helmet 10 as well, including the entirety of the helmet 10.

The particular helmet 10 illustrated in FIGS. 1A-1C is an equestrian riding helmet 10, which is worn by the person 14 while riding a horse 22. In the illustrated embodiment, the head-facing portion 16 includes a liner 24, an adjustment mechanism 26, and a padding 28, which can include a cushioning material such as foam covered or not covered by fabric. The equestrian riding helmet 10 further includes a harness 30. In the illustrated embodiment, the antimicrobial coating 20 is applied to the exterior surface 18 of the padding 28 and can be applied over every exterior surface 18 of the head-facing portion 16, including the liner 24 and adjustment mechanism 26. The antimicrobial coating 20 can also be applied to the exterior surface 18 of the harness 30 and any other exterior surface 18 of the equestrian riding helmet 10.

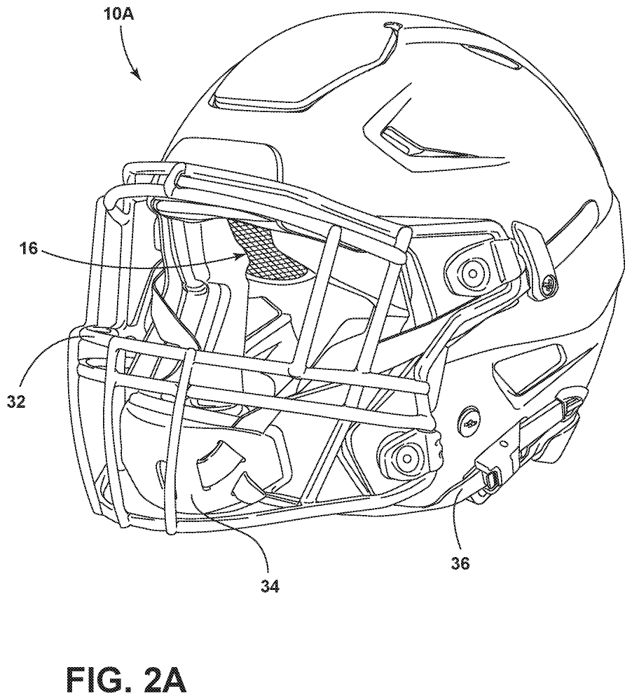

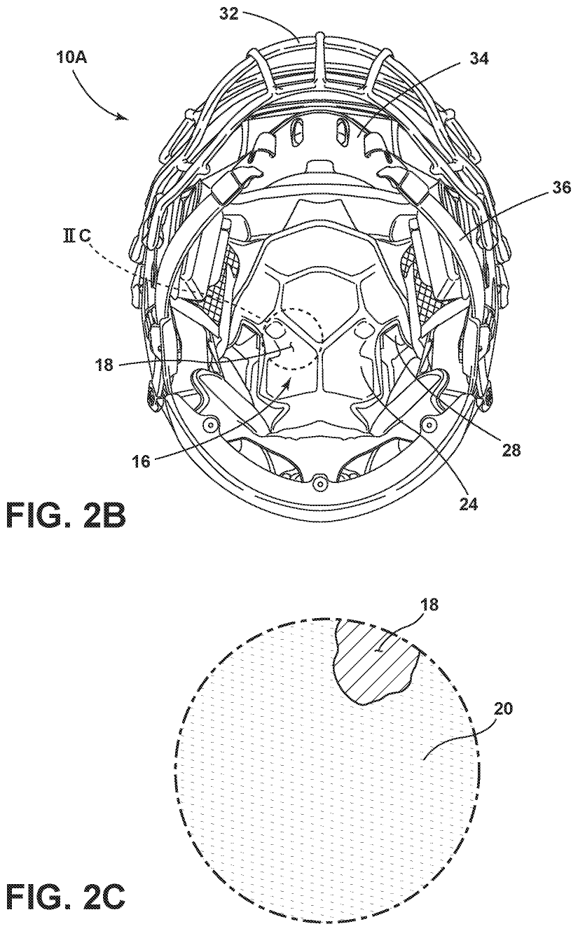

Referring now to FIGS. 2A-2C, a helmet 10A is a football helmet. The football helmet 10A is worn by the person 14 when playing American or Canadian style football. In the illustrated embodiment, the head-facing portion 16 includes the padding 28, as well as the liner 24. The football helmet 10A further includes a facemask 32 and a chin guard 34 connected to the football helmet 10A by straps 36. The antimicrobial coating 20 is applied to the exterior surface 18 of the head-facing portion 16, such as the exterior surfaces 18 of the padding 28 and the liner 24. The antimicrobial coating 20 can also be applied to the exterior surface 18 of the facemask 32, the chin guard 34, and the straps 36, and any other exterior surface 18 of the football helmet 10A.

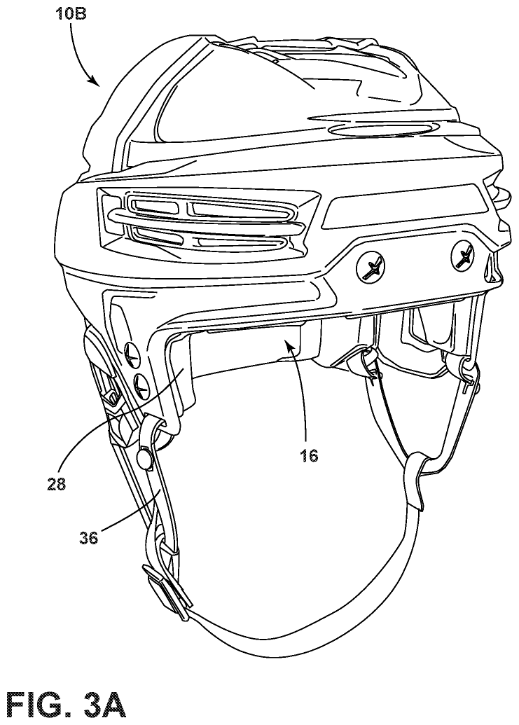

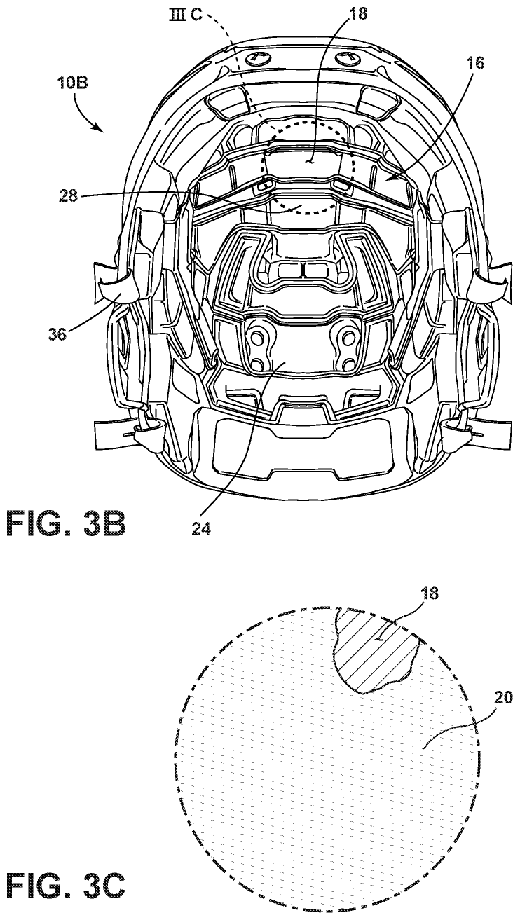

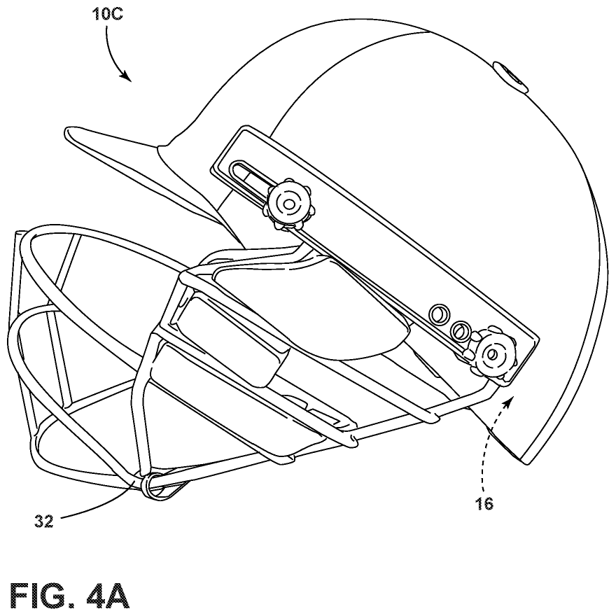

Referring now to FIGS. 3A-3C, a helmet 10B is a hockey helmet. The hockey helmet 10B is worn by the person 14 when playing hockey. In the illustrated embodiment, the head-facing portion 16 includes the padding 28, as well as the liner 24. The hockey helmet 10B further includes the straps 36. The antimicrobial coating 20 is applied to the exterior surface 18 of the head-facing portion 16, such as the exterior surfaces 18 of the padding 28 and the liner 24. The antimicrobial coating 20 can also be applied to the exterior surface 18 of the straps 36, and any other exterior surface 18 of the hockey helmet 10B.

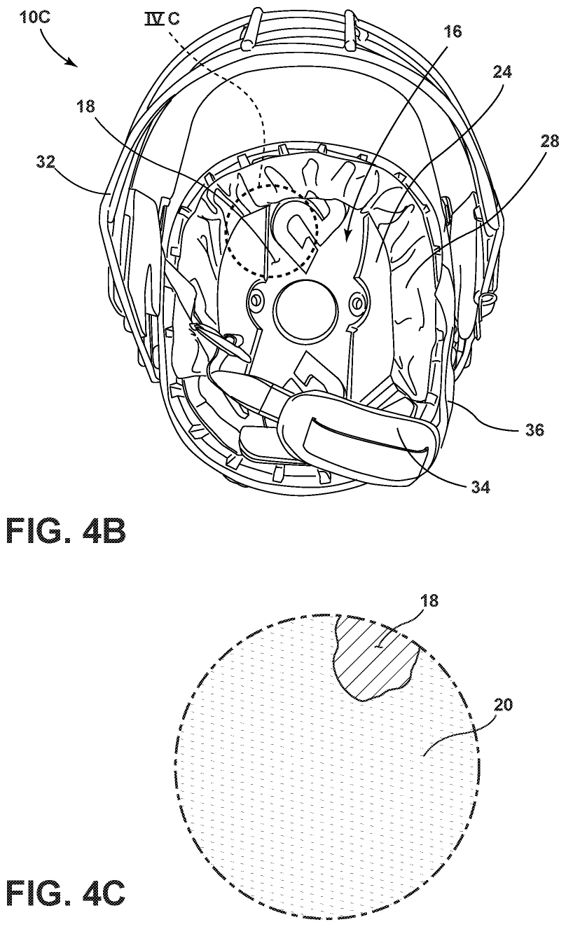

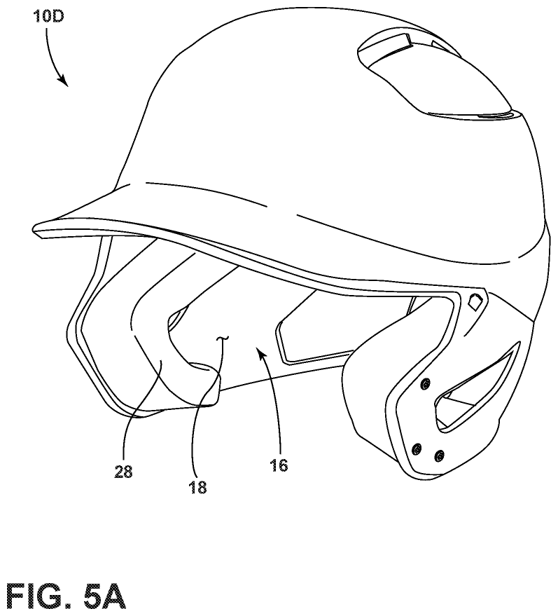

Referring now to FIGS. 4A-4C, a helmet 10C is a cricket helmet. The cricket helmet 10C is worn by the person 14 when playing cricket. In the illustrated embodiment, the head-facing portion 16 includes the padding 28, as well as the liner 24. The cricket helmet 10C further includes the facemask 32 and the chin guard 34 attached to the cricket helmet 10C via the straps 36. The antimicrobial coating 20 is applied to the exterior surface 18 of the head-facing portion 16, such as the exterior surfaces 18 for the padding 28 and the liner 24. The antimicrobial coating 20 can also be applied to the exterior surface 18 of the facemask 32, the chin guard 34, and the straps 36. The antimicrobial coating 20 can also be applied to any exterior surface 18 of the cricket helmet 10C.

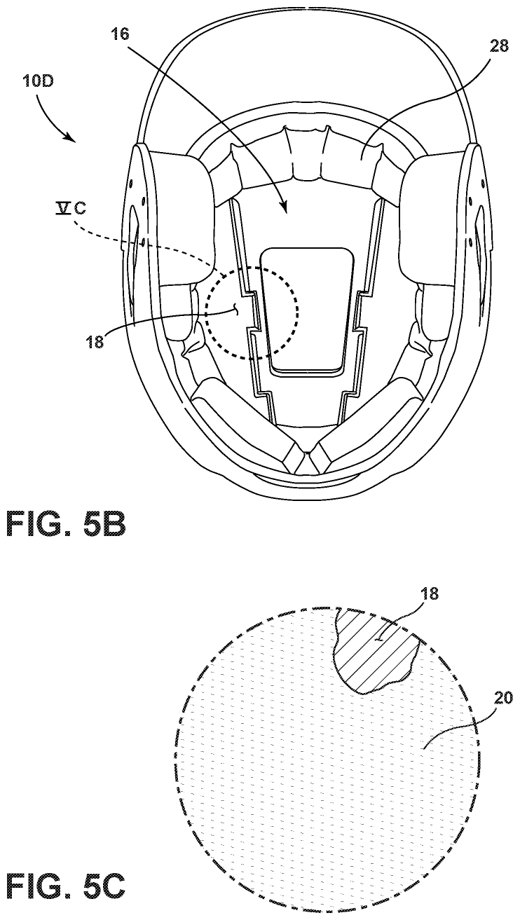

Referring now to FIGS. 5A-5C, a helmet 10D is a batting helmet. The batting helmet 10D is worn by the person 14 when playing baseball. In the illustrated embodiment, the head-facing portion 16 includes the padding 28. The antimicrobial coating 20 is applied to the exterior surface 18 of the head-facing portion 16, such as the exterior surface 18 of the padding 28. The antimicrobial coating 20 can also be applied to any exterior surface 18 of the batting helmet 10D.

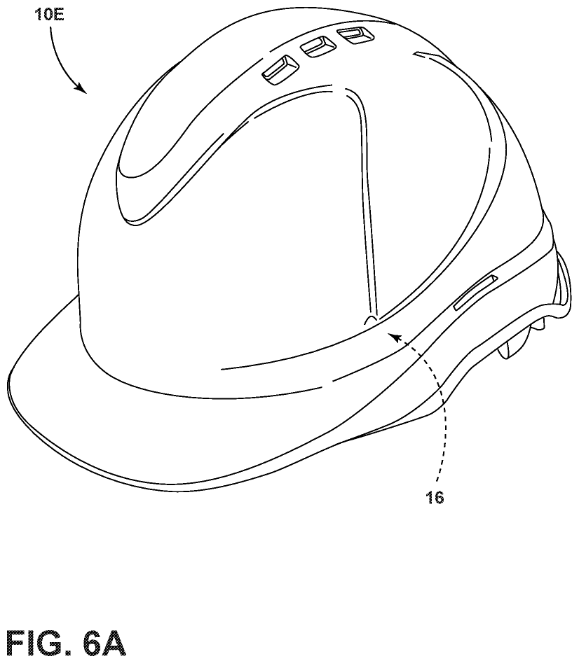

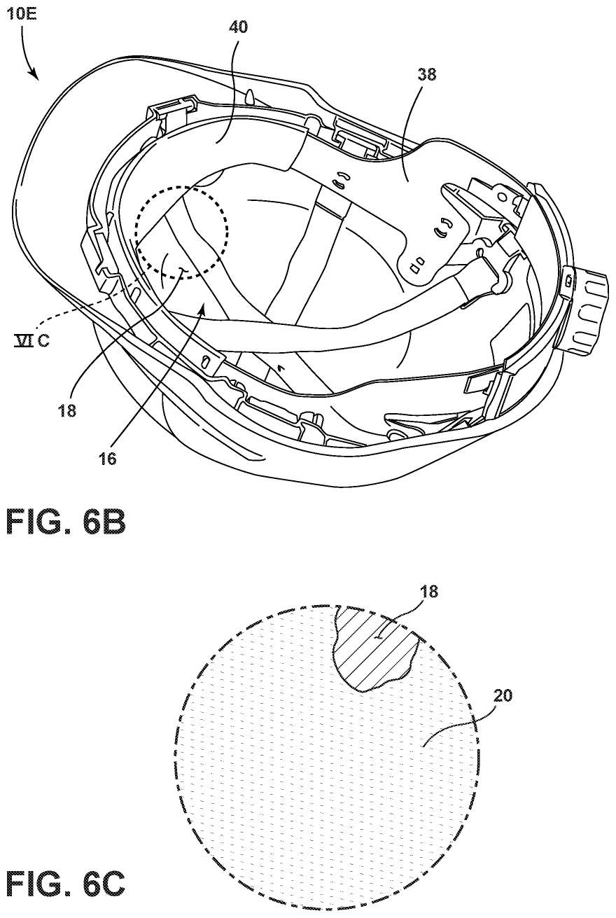

Referring now to FIGS. 6A-6C, a helmet 10E is a hardhat. The hardhat 10E is worn by the person 14 while in an industrial or construction workplace, or the like. In the illustrated embodiment, the head-facing portion 16 includes a suspension mechanism 38, as well as a brow pad 40. The antimicrobial coating 20 is applied to the exterior surface 18 of the head-facing portion 16, such as the exterior surface 18 of the suspension mechanism 38 and the brow pad 40. The antimicrobial coating 20 can also be applied to any exterior surface 18 of the hardhat 10E.

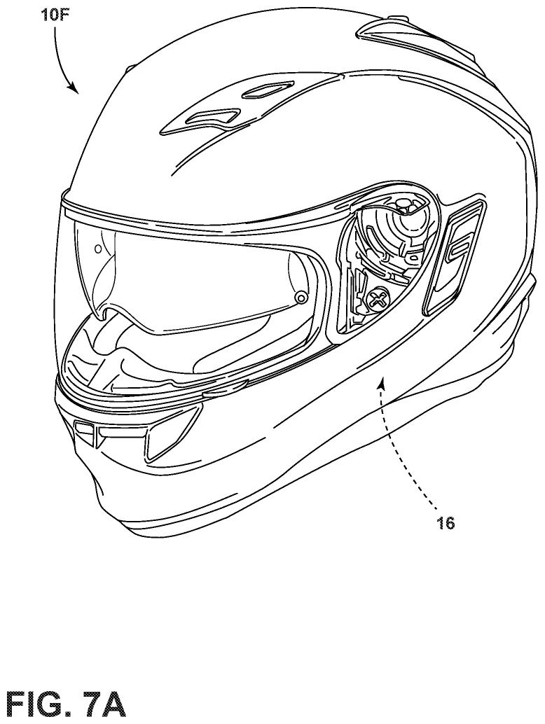

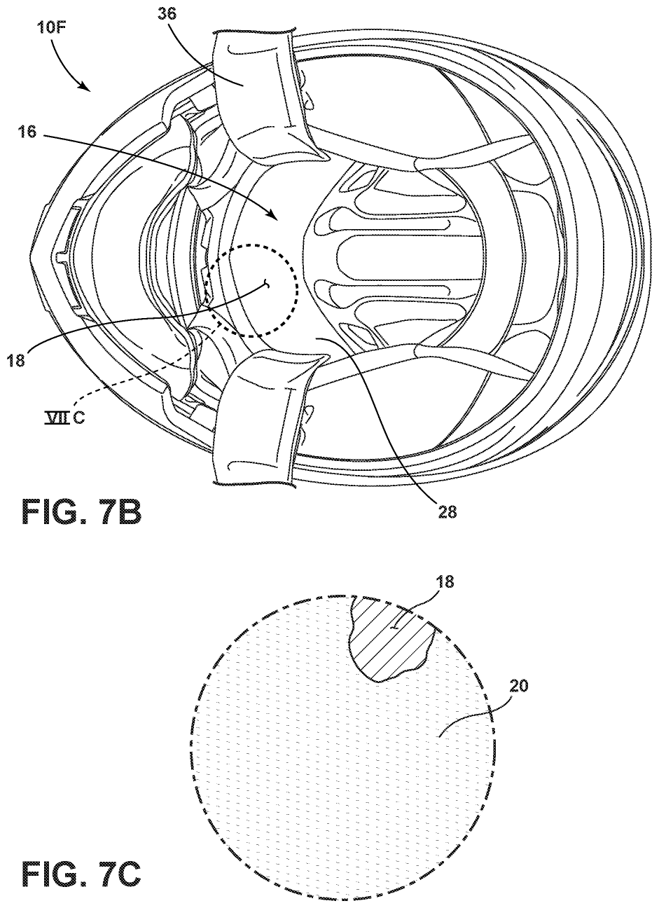

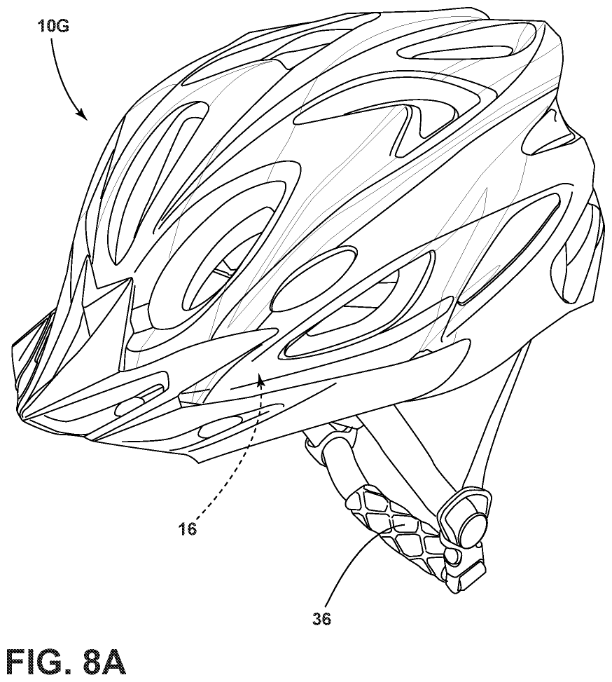

Referring now to FIGS. 7A-7C, a helmet 10F is a motorcycle helmet. The motorcycle helmet 10F is worn by the person 14 while riding a motorcycle. In the illustrated embodiment, the head-facing portion 16 includes the padding 28. The motorcycle helmet 10F further includes the straps 36. The antimicrobial coating 20 is applied to the exterior surface 18 of the head-facing portion 16, such as the exterior surface 18 of the padding 28. The antimicrobial coating 20 can also be applied to the exterior surface 18 of the straps 36. The antimicrobial coating 20 can also be applied to any exterior surface 18 of the motorcycle helmet 10F.

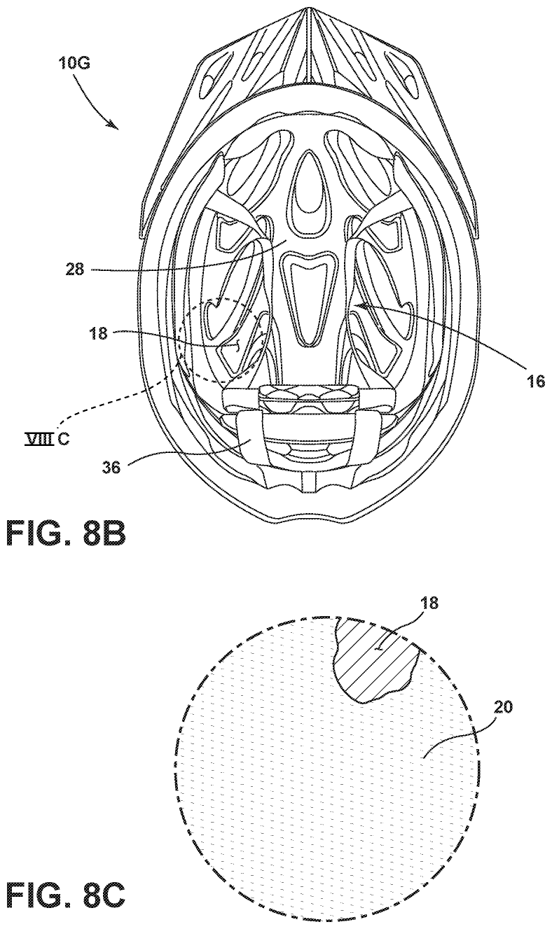

Referring now to FIGS. 8A-8C, a helmet 10G is a bicycle helmet. The bicycle helmet 10G is worn by the person 14 while riding a bicycle. In the illustrated embodiment, the head-facing portion 16 includes the padding 28. The bicycle helmet 10G further includes the straps 36. The antimicrobial coating 20 is applied to the exterior surface 18 of the head-facing portion 16, such as the exterior surface 18 of the padding 28. The antimicrobial coating 20 can also be applied to the exterior surface 18 of the straps 36, as well as to any exterior surface 18 of the bicycle helmet 10G.

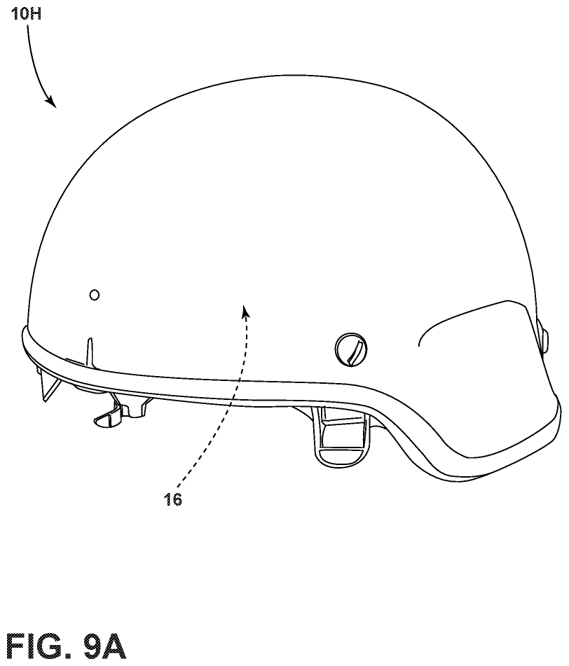

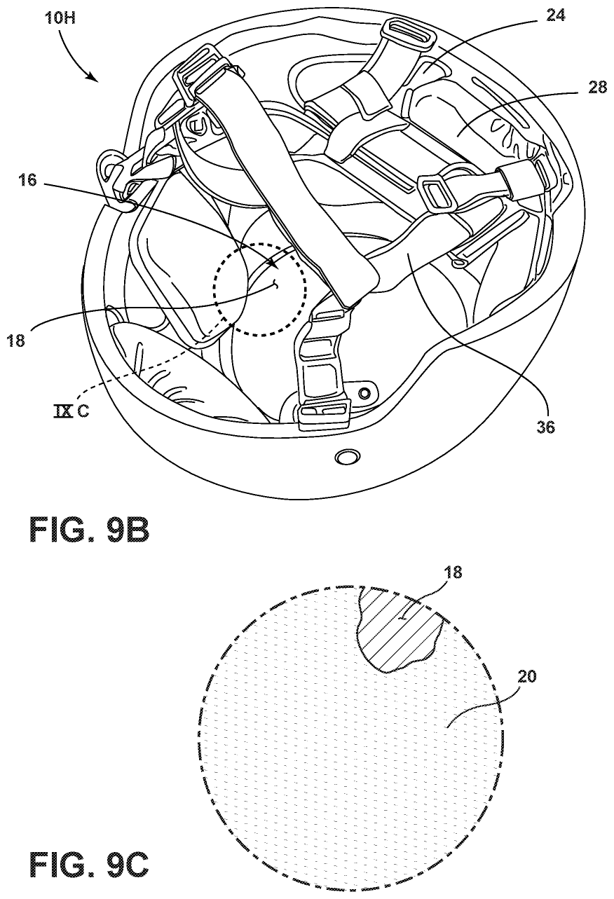

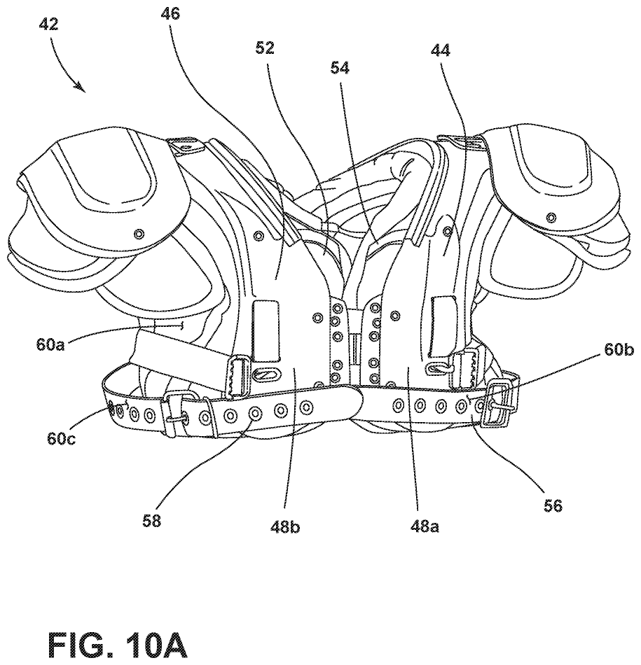

Referring now to FIGS. 9A-9C, a helmet 10H is a combat helmet. The combat helmet 10H is worn by the person 14 while in combat or preparation for combat. In the illustrated embodiment, the head-facing portion 16 includes the padding 28 and the liner 24. The combat helmet 10H further includes the straps 36. The antimicrobial coating 20 is applied to the exterior surface 18 of the head-facing portion 16, such as to the exterior surface 18 of the padding 28 and the liner 24. The antimicrobial coating 20 can also be applied to the exterior surface 18 of the straps 36, as well as to any exterior surface 18 of the combat helmet 10H.

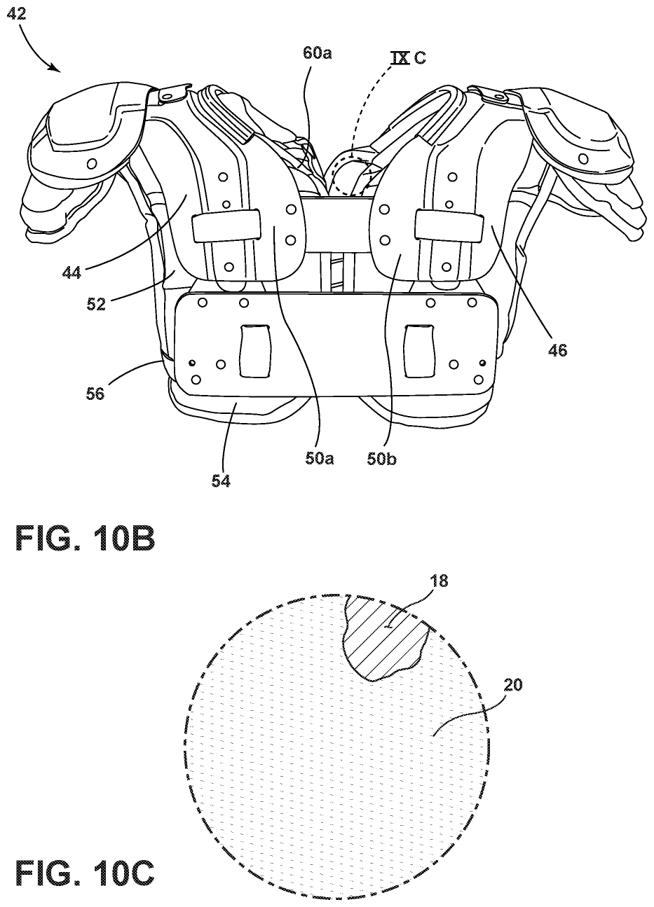

Referring now to FIGS. 10A-10C, sporting shoulder pads 42, such as worn by the person 14 while playing American or Canadian style football, include a left side body arch member 44 and a right side body arch member 46. The left side body arch member 44 and the right side body arch member 46 each include a front portion 48a, 48b, respectively, and a back portion 50a, 50b, respectively. An interior padding assembly 52 is coupled to the left side body arch member 44 and the right side body arch member 46. The interior padding assembly 52 can include a fabric liner 54 covering foam pieces. A left side adjustable belt arrangement 56 is coupled to the front portion 48a and the back portion 50a of the left side body arch member 44. A right side adjustable belt arrangement 58 is coupled to the front portion 48b and the back portion 50b of the right side body arch member 46. The left side adjustable belt arrangement 56 and the right side adjustable belt arrangement 58 allow the person 14 wearing the sporting shoulder pads 42 to adjust how securely the sporting shoulder pads 42 are placed over the person 14. The interior padding assembly 52, the left side adjustable belt arrangement 56, and the right side adjustable belt arrangement 58 all have an exterior surface 60 (e.g., 60a, 60b, 60c, respectively). The exterior surfaces 60 of the interior padding assembly 52, the right side adjustable belt arrangement 58, and the left side adjustable belt arrangement 56, being closest to the person 14 and sweat that the person 14 generates, can become moist and harbor harmful microbes, viruses, bacteria, and the like, which can produce unpleasant odor. To help prevent that, the antimicrobial coating 20 is applied to the exterior surfaces 60, especially the exterior surface 60a of the interior padding assembly 52 that most directly faces the body of the person 14 during use. The antimicrobial coating 20 can be applied to the exterior surface 60 of other components of the sporting shoulder pads 42, as well the entirety of the sporting shoulder pads 42 generally.

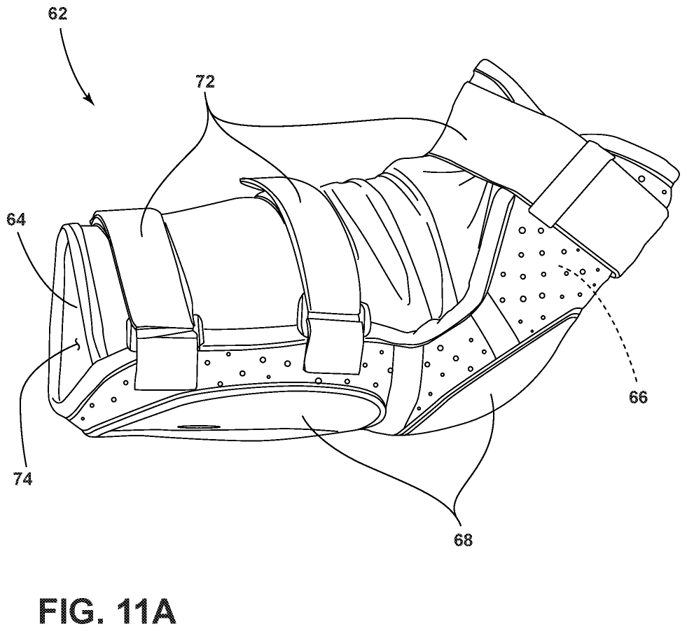

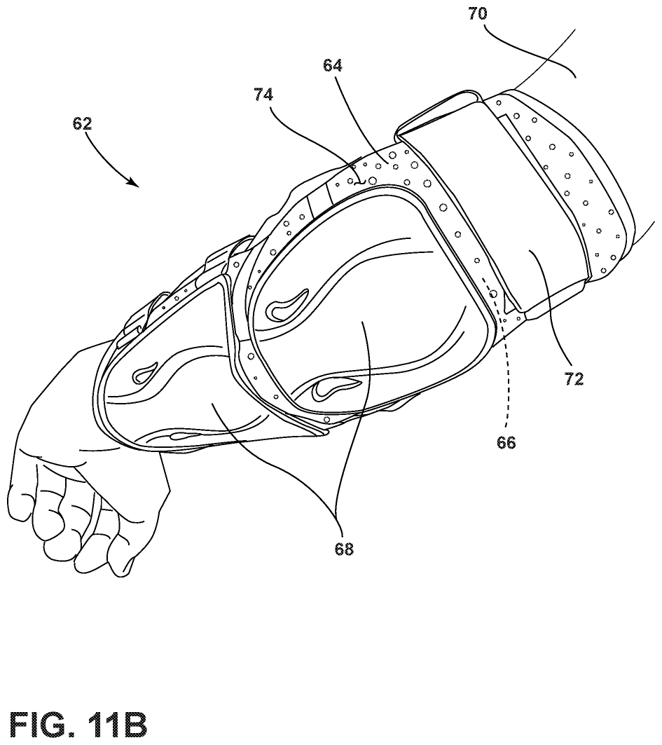

Referring now to FIGS. 11A and 11B, a sporting elbow pad 62 includes a sleeve 64, which can be constructed of a fabric (including an elastic fabric), and a padding element 66 supported by the sleeve 64. The sporting elbow pad 62 can further include a shield 68, such as made from acrylonitrile butadiene styrene (ABS). The sleeve 64 surrounds an arm 70 of the person 14. The sporting elbow pad 62 can further include one or more adjustment straps 72 to help more tightly secure the sporting elbow pad 62 to the arm 70 of the person 14. The padding element 66 can be foam surrounded by the fabric forming the sleeve 64. Exterior surfaces 74 of the sporting elbow pad 62, such as the exterior surface 74 of the sleeve 64, can directly contact the arm 70 of the person 14 and become moist, and can harbor harmful microbes, viruses, bacteria, and the like, which can produce unpleasant odor. To help prevent that, the antimicrobial coating 20 is applied to the exterior surface 74 of the sporting elbow pad 62, especially the exterior surface 74 of the sleeve 64 that faces the body (e.g., contacts the arm 70) of the person 14 during use. The antimicrobial coating 20 can be applied to the exterior surface 74 of other components of the sporting elbow pad 62 as well, such as the adjustment straps 72, and applied to the exterior surface 74 of the sporting elbow pad 62 generally.

The antimicrobial coating 20 applied to the exterior surfaces 18, 60, 74, mentioned above includes a silane quaternary ammonium ion or salt thereof. Preferred silane quaternary ammonium ions or salts thereof include 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride. Applying the antimicrobial coating 20 to the various exterior surfaces 18, 60, 74, described above imparts antimicrobial properties on the various exterior surfaces 18, 60, 74, which prevents or lessens the ability of said exterior surfaces 18, 60, 74, to harbor harmful microbes, viruses, bacteria, and the like, and to produce unpleasant odor. Applying the antimicrobial coating 20 to the various exterior surfaces 18, 60, 74, serves to lessen the ability of the helmets 10-10H, the sporting shoulder pads 42, and the sporting elbow pad 62 to act as vehicles that transmit the harmful microbes, viruses, bacteria, and the like to the person 14 wearing them, and to produce unpleasant odor.

Further described herein is a novel method of imparting antimicrobial properties (i.e., applying the antimicrobial coating 20) onto any of the exterior surfaces 18, 60, 74, of any of the helmets 10-10H, sporting shoulder pads 42, and sporting elbow pads 62 described above. The method comprises presenting any of the helmets 10-10H, sporting shoulder pads 42, and sporting elbow pads 62 described above with the exterior surfaces 18, 60, 74, respectively. The method further comprises applying, to one or more of the exterior surfaces 18, 60, 74, a solution including the silane quaternary ammonium ion or salt thereof, as described above. In addition to the silane quaternary ammonium ion or salt thereof, the solution can further include a solvent. A preferred solvent is isopropyl alcohol.

The silane quaternary ammonium ion or salt thereof can comprise between 0.1 percent and 10 percent by weight of the solution. More preferably, the silane quaternary ammonium ion or salt thereof can comprise between 0.75 percent and 5 percent by weight of the solution. Even more preferably, the silane quaternary ammonium ion or salt thereof can comprise between 1.9 percent and 2.1 percent by weight of the solution.

As for the isopropyl alcohol, the isopropyl alcohol can comprise between 30 percent to 90 percent by weight of the solution. More preferably, the isopropyl alcohol can comprise between 55 percent and 65 percent by weight of the solution. An example preferable solution comprises (by weight) 60.0 percent isopropyl alcohol, 2.02 percent 3-(trimethoxysilyl)propyldimethyloctadecyl ammonium chloride, and 34.19 percent deionized water.

It is to be understood that variations and modifications can be made on the aforementioned structure without departing from the concepts of the present disclosure, and further it is to be understood that such concepts are intended to be covered by the following claims unless these claims by their language expressly state otherwise.

1. A helmet comprising:
a head-facing portion shaped to partially surround a head of a person, the head-facing portion including an exterior surface to contact the head of the person; and
an antimicrobial coating applied to the exterior surface of the head-facing portion;
wherein, the antimicrobial coating includes a silane quaternary ammonium ion or salt thereof and isopropyl alcohol.

2. The helmet of claim 1,
wherein, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

3. The helmet of claim 1,
wherein, the helmet is an equestrian riding helmet, the head-facing portion includes padding, and the antimicrobial coating is applied to the exterior surface of the padding.

4. The helmet of claim 1,
wherein, the helmet is a football helmet, the head-facing portion includes one or more of padding and liner, and the antimicrobial coating is applied to the exterior surface of the one or more included padding and liner.

5. The helmet of claim 1,
wherein, the helmet is a hockey helmet, the head-facing portion includes padding, and the antimicrobial coating is applied to the exterior surface of the padding.

6. The helmet of claim 1,
wherein, the helmet is a cricket helmet, the head-facing portion includes one or more of padding and liner, and the antimicrobial coating is applied to the exterior surface of the one or more included padding and liner.

7. The helmet of claim 1,
wherein, the helmet is a batting helmet, the head-facing portion includes padding, and the antimicrobial coating is applied to the padding.

8. The helmet of claim 1,
wherein, the helmet is a hardhat, the head-facing portion includes a suspension mechanism, and the antimicrobial coating is applied to the exterior surface of the suspension mechanism.

9. The helmet of claim 1,
wherein, the helmet is a motorcycle helmet, the head-facing portion includes padding, and the antimicrobial coating is applied to the exterior surface of the padding.

10. The helmet of claim 1,
wherein, the helmet is a bicycle helmet, the head-facing portion includes padding, and the antimicrobial coating is applied to the exterior surface of the padding.

11. The helmet of claim 1,
wherein, the helmet is a combat helmet, the head-facing portion includes one or more of padding, and liner, and the antimicrobial coating is applied to the exterior surface of the one or more included padding and liner.

12. The helmet of claim 1 further comprising:
a strap including an exterior surface;
wherein, the antimicrobial coating is further applied to the exterior surface of the strap.

13-18. (canceled)
